(19) United States
(12) Patent Application Publication
(10) Pub. No.: US 2005/0004900 A1
(43) Pub. Date: Jan. 6, 2005

(54) Information search method

(76) Inventors: Yoshihiro Ohta, Tokyo (JP); Tetsuo Nishikawa, Tokyo (JP); Hiroko Ohi, Kokubunji (JP); Toru Hisamitsu, Oi (JP)

Correspondence Address: REED SMITH LLP, Suite 1400, 3110 Fairview Park Drive, Falls Church, VA, 22042, US

(21) Appl. No.: 10/841,525

(22) Filed: May 10, 2004

(30) Foreign Application Priority Data
May 12, 2003 (JP) 2003-132846

(51) Int. Cl. G06F 17/30

(52) U.S. Cl. 707/3

(57) ABSTRACT

New information is extracted efficiently and exhaustively to predict the function of genes or proteins. First, known-sequence data with high relevance to a search object sequence or structure information is obtained using a sequence database. Then, documents relevant to the resultant known-sequence data are retrieved, using a document database. Feature words common to a plurality of documents extracted are extracted and outputted.

The present application claims priority from Japanese application JP 2003-132846 filed on May 12, 2003, the content of which is hereby incorporated by reference into this application.

### BACKGROUND OF THE INVENTION

1. Technical Field

The present invention relates to a method of predicting the function of gene or protein, and more particularly to a method of predicting the function of a search object sequence, using a text mining technique.

2. Background Art

Conventionally, researches into genomic drug discovery are conducted through the processes of identification of individual genes by genomic study, clarification of the function of individual genes, search for and identification of drug discovery target proteins, discovery of lead compounds and optimization of structure, study of safety and pharmacodynamics, pharmacogenomic research, and clinical trial, for example. In this case, the researchers are inundated by the flood of information from the initial stage of genomic study. According to the announcement of the Human Genome Project team, there are 30 to 40 thousand human genes. Therefore, in order to investigate the validity of the human genes as a drug discovery target, tremendous amounts of cost- and time-consuming experimentation must be performed.

In order to narrow the genes/proteins that can be targets, function prediction methods employing a query sequence (newly determined sequence with unknown functions) have been proposed, of which major examples are similarity searches and motif searches. In the homology search, which is a type of similarity search, a query sequence is compared with each of the known sequences in a database. If there is a similar sequence in the database, it is predicted that the function of the query sequence is also similar to the function of the similar sequence (see Non-patent Documents 1 and 2). In the motif search, a sequence motif (localized conserved sequence pattern) characterizing a specific function group is extracted from known sequences and a library is prepared, based on which a search is conducted (see Non-patent Document 3). In both methods, public databases are searched for information concerning a sequence or a sequence group that is homologous to the sequence with unknown functions, or data in a database constructed from original data is allocated as the predicted function of a sequence with unknown functions.

[Non-patent Document 1] “Basic local alignment search tool”, Altschul, S. F., Gish, W., Miller, W., Myers, E. W. & Lipman, D. J. (1990) J. Mol. Biol. 215:403-410.

[Non-patent Document 2] “Identification of protein coding regions by database similarity search”, Gish, W. & States, D. J. (1993) Nature Genet. 3:266-272

[Non-patent Document 3] “Pfam: multiple sequence alignments and HMM-profiles of protein domains”, Sonnhammer E L L, Eddy S R, Birney E, Bateman A, Durbin R (1998) Nucleic Acids Research 26: 320-322.

### SUMMARY OF THE INVENTION

For the sequences of known functions, various experiments have been conducted by researchers of various countries. Vast amounts of information obtained by the experiments are only partly stored in databases and there is much information that is not made available in the form of databases and which is believed to be hidden among papers written by researchers. Because the aforementioned similarity search and motif search are based on the information stored in databases, they have the problem of shortage of information. The most important things in drug discovery are: searching genome information (genomic sequences, full-length cDNA sequence information, and expression profile information) or SNP for drug-discovery target genes; directly reflecting the research results of structural genomics on efficient drug designing; and incorporating SNP information into clinical development early, so as to reduce the development time and achieve cost reductions. There has also been the problem that, due to the absence of means for investigating the available experiment information in an exhaustive manner, the drug-discovery targets cannot be narrowed, resulting in repeating experiments in the field in which experiments have already been conducted.

In view of these problems of the prior art, it is the object of the invention to provide a method of predicting the function of genes or proteins by extracting new information in an efficient and exhaustive manner.

In accordance with the invention, the aforementioned object is achieved by employing a method of predicting the function of sequences with unknown functions whereby reference is made to knowledge stored in as many as 10 million references, in addition to the knowledge stored in databases to which reference is made exclusively by the conventional method. The information obtained from the references is displayed to the user by means of several visualization tools in an easily understandable manner, thereby facilitating the discovery of information that is not obtainable from the database alone, or the prediction of the function of sequences.

The invention provides an information search method comprising:
entering a query;
searching a database in which the same kind of data as the query is stored for an entry with a high level of relevance to the query;
searching a document database for documents related to a retrieved entry;
extracting a feature term common to at least two of the retrieved documents; and
displaying the extracted feature term. The query is typically a sequence or structure information indicating the three-dimensional structure of protein, and the database in which the same kind of data as the query is stored is a sequence database.

Preferably, the step of searching for the documents comprises performing an associative search using documents contained in the retrieved entries as key documents. The associative search may be performed using a plurality of document databases.

The extracted feature terms are preferably classified by concept, such as disease, before being outputted. It is also effective to employ a method whereby the extracted feature terms are sorted by frequency of appearance and then displayed together with information about the frequency of appearance, or a method whereby the extracted feature terms are sorted by E-value and then displayed together with information about the E-value.

### BRIEF DESCRIPTION OF THE DRAWINGS

FIG. 1 shows a flowchart illustrating the outline of the processes performed in accordance with the invention.

FIG. 2 shows a flowchart of an example in which the method of the invention is adapted for the search for the function of proteins with unknown functions.

FIG. 3 shows how entries are made for homology search using a query, and an example of the display of the results of homology search.

FIG. 4 shows the process of associative search performed on references related to homologous sequences.

FIG. 5 shows an example of the display of a keyword list.

FIG. 6 shows an example of the display of a keyword matrix.

FIG. 7 shows an example of visualization of cooccurence of keywords.

### DESCRIPTION OF THE PREFERRED EMBODIMENTS

Embodiments of the present invention will be described by referring to the drawings. The present invention is based on the premise that an environment exists in which access can be made, via communications networks such as the Internet, to search engines or databases, such as public databases, in which sequence information and information about the function of proteins are stored. The invention may utilize the existing databases and search engines, and therefore their detailed descriptions are omitted.

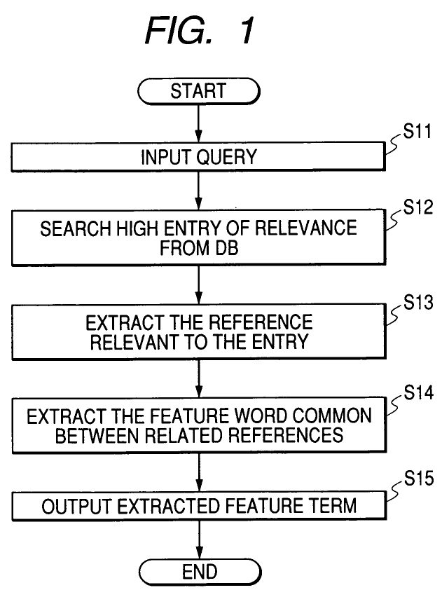

FIG. 1 shows a flowchart of the processes performed by the invention. First, a query, such as a sequence to be investigated, is entered (S11). A database is then searched for entries with high relevance to the query (S12). Usually, a plurality of entries with high relevance to the query are retrieved from the database. Then, documents related to the entries are retrieved (S13). In this process, documents that are listed as references in each of the retrieved entries are listed, for example. The contents of the thus listed documents are then searched for feature terms, which are terms that commonly appear in two or more documents (S14). Finally, the extracted feature terms are displayed on a display using an appropriate display method. Such extracted feature terms possibly indicate an aspect of the characteristics of the query. In the present invention, the search objects are expanded to those research papers that are stored in document databases, or “raw” data. Thus, it is possible to obtain information that have been overlooked by the conventional searches that search public databases, in which the data stored have been extracted from raw data and processed in accordance with personal experiences.

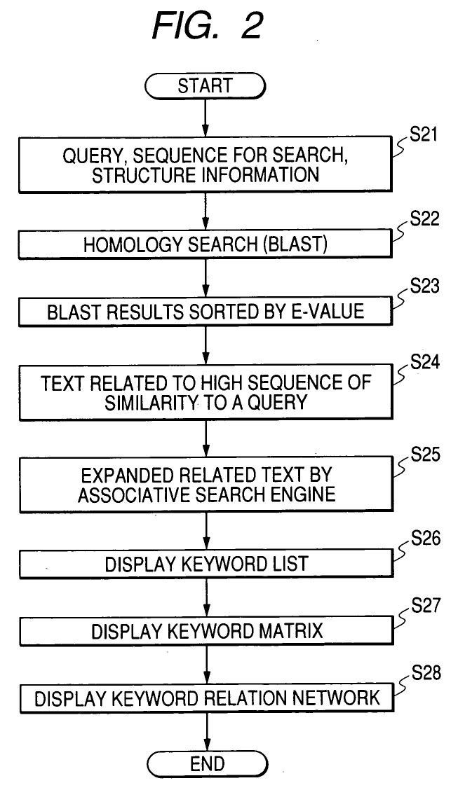

FIG. 2 shows a flowchart illustrating an example in which the method of the invention is adapted for the search for the function of proteins of unknown functions.

First, a query concerning the sequence data or structure information as an object of analysis is entered (S21). What is entered as a query is sequence data about the protein that the researcher has analyzed, for example. Then, a homology search is conducted to search for sequences similar to the query (S22). Specifically, a homology search is conducted on protein amino acid sequence databases, such as SWISS-PROT, recognizing even low levels of homology. In this search, the base sequences are translated into amino-acid sequences while searching for homologous intervals.

Then, the sequences that have been found in step 22 that are homologous to the query are sorted in the order of E-value, for example, which will be described later. The results of homology search, such as the protein names, E-values, the number of relevant references, and the names of the entries in the protein amino acid database, such as the entry names of SWISS-PROT, are displayed (S23). Then, relevant references of the sequences with high homology to the query are extracted (S24). In this process, the MEDLINE IDs of the references in the entries of SWISS-PROT that have been found in step 22, or the number of documents, are determined. The relevant references with high homology to the query are then retrieved again, using the associative search engine GETA (S25). Then, keywords contained in the relevant references that have been re-retrieved and expanded by the associative search are displayed (S26). The display may show the number of references that contain the keywords in a matrix (S27), or it may show the number of cooccurence among keywords counted in the documents, in a table (S28).

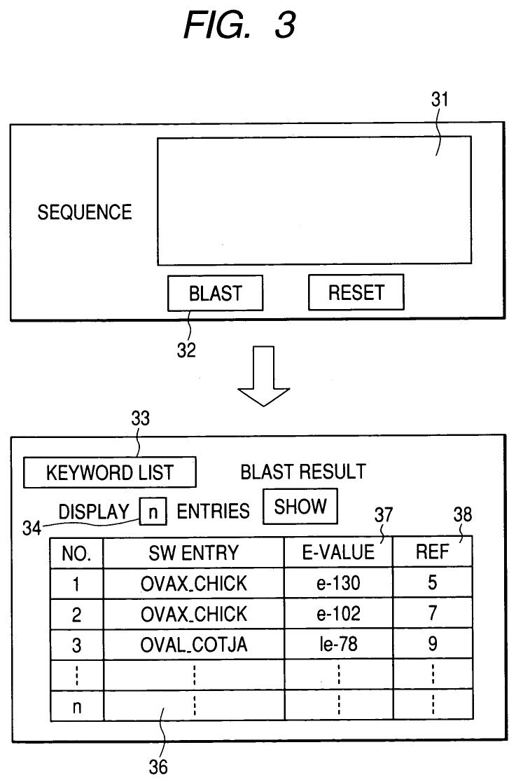

FIG. 3 shows the outline of the homology search process shown in steps 21 and 22 of FIG. 2 and a method of displaying the result of BLAST.

The search-object sequence or structure information as the query is entered in an input box 31. In response to the entered query, a homology search is conducted on a protein amino acid sequence database, such as SWISS-PROT, recognizing even low levels of homology. This search, in which the base sequences are translated into amino-acid sequences while searching for homologous intervals, can be conducted by using known techniques, such as NCBI's BLAST (Altschul, Stephen F., Thomas L. Madden, Alejandro A. Schaffer, Jinghui Zhang, Zheng Zhang, Webb Miller, and David J. Lipman (1997), “Gapped BLAST and PSI-BLAST: a new generation of protein database search programs”, Nucleic Acids Res. 25:3389-3402.). By conducting the homology search using BLAST, information concerning the sequences with high homology, such as the type of the database, accession number, the entry names of the database, scores, and E-values, can be obtained. The score refers to “a point obtained by summing up the positive values that are given when there are identical residues at the same position of two sequences arranged side by side, and the negative values that are given when the residues at the same position are different. The higher the score, the higher the homology. The E-value refers to “an expected value of the number of sequences that have the same score purely by chance in the current database.” The smaller the E-value, the smaller the chance. Thus, if the score is large and the E-value is small, it can be said that the homology between individual sequences is high. As a button 32 is pressed, a homology search by BLAST is performed, and the results are displayed as shown at the bottom of the drawing.

When a homology search is performed to retrieve sequences that are homologous to the query, such as a search object sequence or sequence information, several sequences that can be considered highly homologous are obtained. The entries of the known sequences assumed to be highly homologous are then displayed on the result display screen in the order of decreasing homology. In the illustrated example, the number of results to be displayed can be designated in an input box 34, and as many entries as the designated number are listed. The default number of sequence outputs is 50. The output items in the table include item 36 for the entry names of a protein amino acid sequence database, such as SWISS-PROT, item 37 for the value indicating the degree of homology, such as the E-value, and item 38 for the number of references. The number of references indicates the number of references in the entries that are relevant to the homologous sequences found by the search in step 22, in which an amino acid sequence database, such as SWISS-PROT, is referred to. The results of the homology search, namely the homologous sequences, are sorted by a value indicating the degree of homology, such as the E-value, and then displayed. When the E-value is used as the value indicative of the degree of homology, the sequences are sorted in increasing degrees of homology. Links are put from entry names 36, namely SWISS-PROT entry names in the example, to relevant protein amino acid sequence database pages. Links are also put from the number of references 38 to MEDLINE. As a button 33 is pressed, a KEYWORD LIST is displayed.

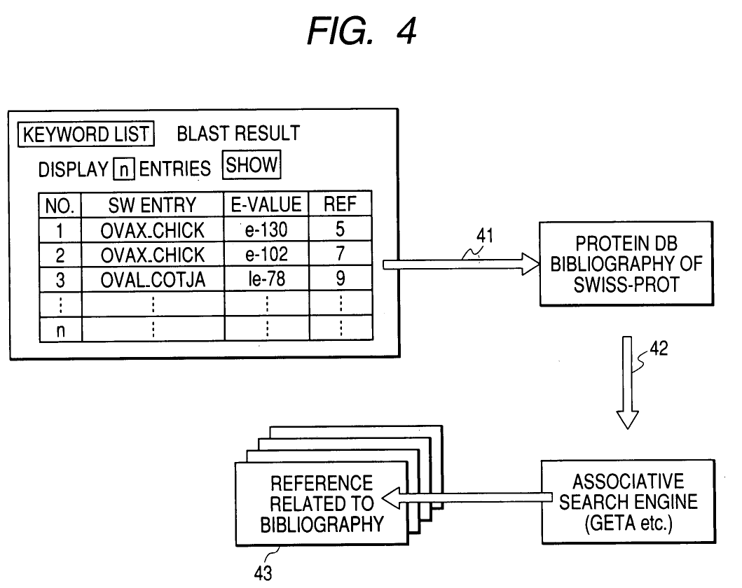

FIG. 4 shows the outline of a relevant reference re-search process utilizing an associative search engine. In a process 41, the references cited in the entries related to the homologous sequences obtained in step 24 of FIG. 2 are rendered into key documents. In a process 42, the key documents are handed over to an associative search engine, such as GETA, in order to perform an associative search for references that are highly relevant to the key documents. As a result of the associative search, references 43 that are highly relevant to the key documents are obtained. The associative search engine is a search engine based on a search scheme (associative search) such that 50 to 200 characteristic words contained in the key documents are automatically selected, and calculations (associative calculations) are performed based on such information (index data) as the frequency of appearance of the selected words and their mutual relevance, for example, in order to immediately retrieve documents related to the key documents (see, for example, JP Patent Publication (Kokai) Nos. 11-85786 A (1999) and 2002-222210 A).

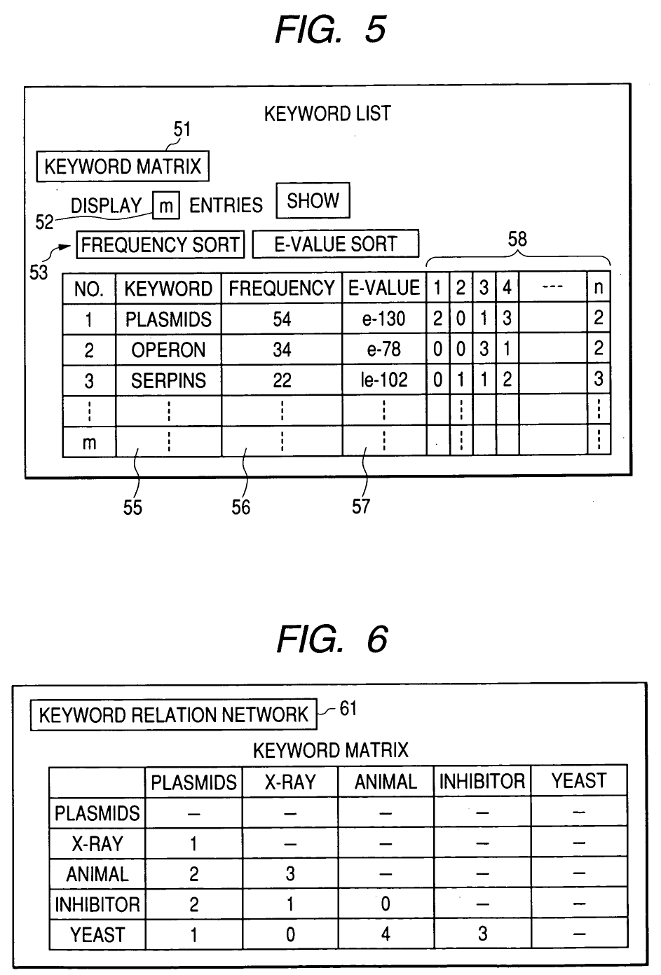

Now referring to FIG. 5, the display of the keywords present in an expanded group of references that have been re-retrieved by the associative search engine will be described.

FIG. 5 shows a result display screen in which the keywords that appear in the references in the expanded reference set obtained by the associative search in step 25 of FIG. 2 are displayed. The keywords herein refer to the common substance names, terms indicating functions, protein names, interaction names, etc. The keywords can be extracted by a variety of methods, such as: a method whereby keywords are extracted from references including dictionaries of common substance names, terms indicating functions, and protein names, etc.; a method whereby ontologies are extracted from Gene Ontology, for example; a method whereby keywords are selected from references using statistical quantities such as tf·idf; and a method whereby keywords are extracted from references according to part-of-speech information. In order to eliminate commonplace keywords, a stop-word set is created beforehand. The “tf (term frequency)” and “idf (inverse document frequency)” are expressed by the following equations:
tf(d, t)=(frequency of appearance of keyword t in document d)
idf(t)=log(DBsize(db)/freq(t, db))+1

The DBsize(db) is the total number of references included in the object document database, and the freq(t, db) is the number of documents in the document database in which term t appears. The weight (d, t) of keyword t in document d is obtained by combining them both, i.e., weight (d, t)=tf(d, t)*idf (t). According to the method whereby keywords are selected from references using tf·idf, keywords with high weight are extracted from the references.

As shown in FIG. 5, in the display KEYWORD LIST, keywords are shown in column 55, the frequency of appearance in references is shown in column 56, the best values of E-values of the sequences related to the keywords are shown in column 57, and the frequency of appearance of the homologous sequences in the references cited in SWISS-PROT are shown in column 58. According to the display of FIG. 5, the keyword “Plasmid” appears 54 times in the references retrieved by the associative search, the best value of the E-value of the sequences related to the keyword “Plasmid” is e-130, the keyword “Plasmid” appears twice in the first reference, never in the second reference, once in the third reference, four times in the fourth reference, and twice in the n-th reference. Upon pressing of button 53, the keywords can be sorted by the frequency of appearance in references or by the E-value. The number of results displayed can be adjusted in an input box 52. In the default mode, 50 keywords are set to be displayed. By pressing button 51, a KEYWORD MATRIX can be displayed.

FIG. 6 shows an example of the display of KEYWORD MATRIX, in which the number of cooccurence of keywords counted in the references is tabulated. The keywords are shown on the vertical and horizontal axes, and the number of cooccurence of two keywords is shown in cells at intersections. There are various degrees of cooccurence, such as cooccurence in a single reference, cooccurence in one paragraph in a single reference, cooccurence in one sentence, and cooccurence within 20 words before and after the keyword of interest. The degree may be appropriately designated by the user. By pressing button 61, a KEYWORD RELATION NETWORK can be displayed.

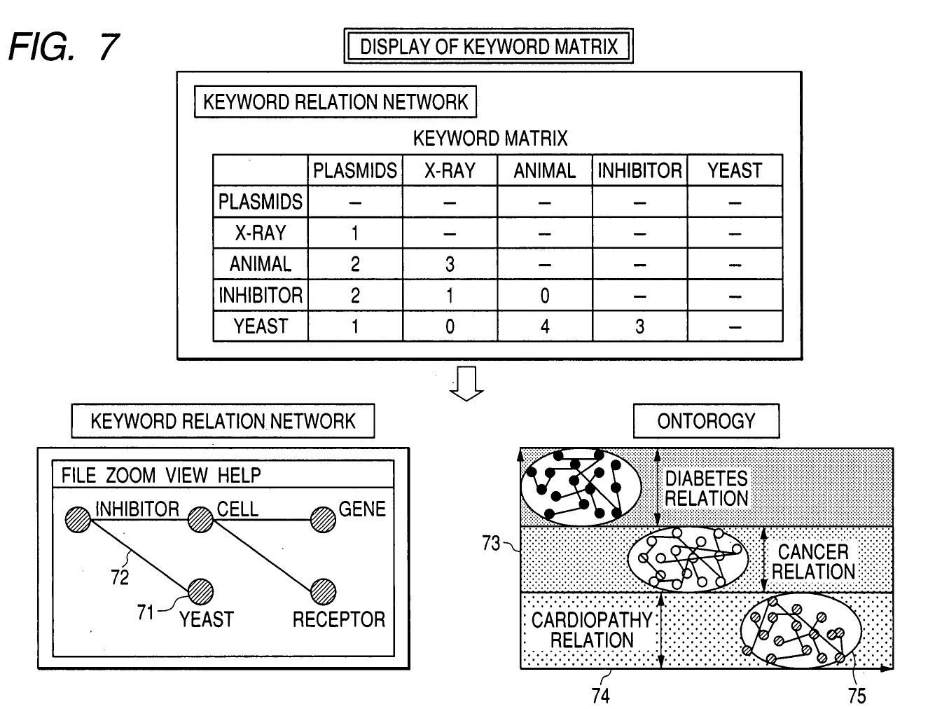

FIG. 7 illustrates the visualization of the cooccurence of the keywords. In the following, two types of visualization methods will be described.

In the display screen KEYWORD RELATION NETWORK, the nodes represented by white circles 71 indicate the keywords, and the lines (edges) 72 connecting the nodes indicate the relationships between the keywords. The color and/or thickness of the edges are varied depending on the number of cooccurence. This viewer allows the user to recognize the relevance between the keywords easily.

In the ONTOLOGY display screen, the keywords obtained from the references are sorted by as much diagonalization as possible, or by the setting of a slider bar giving a threshold for the E-value, the protein function name, the disease name, or the substance name, for example, before being displayed. In the illustrated example, the keywords are sorted by disease name on the vertical axis 73. On the horizontal axis 74, such keywords as the gene or protein names are arranged in decreasing order of importance (such as E-value). Clustering by the disease names or the like can be conducted by utilizing an ONTOLOGY database, such as G-ONTOLOGY. The display is made such that, as shown in 75, the keywords such as the gene or protein names are contained in the nodes and the cooccurence or interaction is contained in the edges. The E-value may be reflected in the density of the displayed color of the nodes. Thus the relevant keywords can be presented according to disease or protein function in a more understandable manner using ONTOLOGY, thus facilitating the function prediction operation performed by biomedical experts.

Thus, the invention facilitates the discovery or prediction of the function of a query, such as a search object sequence or structure information, from vast amounts of references related to homologous sequences with known functions. The functions extracted from the references can be visualized by means of a viewer, thus facilitating the function prediction by biomedical experts. While the prior art has been unable to provide sufficient prediction and required time-costly experimentation, due to its inability to deal with the known knowledge in an exhaustive manner, higher levels of efficiency can be obtained by the present invention.

1. An information search method comprising:
entering a query;
searching a database in which the same kind of data as said query is stored for an entry with a high level of relevance to said query;
searching a document database for documents related to a retrieved entry;
extracting a feature term common to at least two of the searched documents; and
displaying the extracted feature term.

2. The information search method according to claim 1, wherein said query is a sequence or structure information, and said database in which the same kind of data as said query are stored is a sequence database.

3. The information search method according to claim 1, wherein the step of searching for said documents comprises performing an associative search using documents cited in the retrieved entries as key documents.

4. The information search method according to claim 1, wherein the extracted feature terms are classified by concept before being outputted.

5. The information search method according to claim 2, wherein the extracted feature terms are classified by disease before being outputted.

6. The information search method according to claim 1, wherein the extracted feature terms are sorted by frequency of appearance and then displayed together with information about said frequency of appearance.

7. The information search method according to claim 1, wherein the extracted feature terms are sorted by E-value and then displayed together with information about E-value.
